(19) United States
(12) Patent Application Publication
(10) Pub. No.: US 2013/0100421 A1
(43) Pub. Date: Apr. 25, 2013

(54) LIGHT SOURCE DEVICE AND PROJECTOR

(71) Applicants: CHIEN-WEN HSU, Tu-Cheng (TW); WEN-PIN YEH, Tu-Cheng (TW)

(72) Inventors: CHIEN-WEN HSU, Tu-Cheng (TW); WEN-PIN YEH, Tu-Cheng (TW)

(73) Assignee: HON HAI PRECISION INDUSTRY CO., LTD., Tu-Cheng (TW)

(21) Appl. No.: 13/473,625

(22) Filed: May 17, 2012

(30) Foreign Application Priority Data
Oct. 24, 2011 (TW) 100138549

(51) Int. Cl. G03B 21/28; G03B 21/14; F21V 9/00

(52) U.S. Cl. 353/33; 362/231

(57) ABSTRACT

A projector includes a projection lens set, a digital micro-mirror device (DMD), a prism unit, a light merging unit, a light guide unit, and a light source device. The light source device includes a laser light source and a color wheel. The laser light source is positioned in an optical path and generates a first light. The color wheel is positioned in the optical path. The first light irradiates the color wheel to generate second and third lights. The light merging unit merges the first, second, and third lights to generate a mixed light. The light guide unit guides the mixed light to the prism unit. The mixed light is refracted to the DMD via the prism unit, and the refracted mixed light is reflected to the projection lens set via the DMD.

### BACKGROUND

1. Technical Field

The present disclosure relates to a light source device and a projector having a light source device.

2. Description of Related Art

Heightened requirements are imposed on the imaging quality of projectors. A projection system primarily includes a light source device and a projection lens set. Emphasis has been put on improving the arrangement reliability of components, to shrink the overall volume and increase the light source efficiency in the light source device to enhance the imaging brightness in the back-end projection lens set.

To improve the image brightness, a conventional projector utilizes a number of light sources to provide various color lights. However, the light sources of such light source devices not only lead to a complex and bulky design of the internal structure of the projector, but also causes a build up of heat, exacerbated by poor heat dissipation. After a period of operation, the high temperatures tend to shorten the lifetime of the projector and cause damage to the light source device.

Thus, there is a need for a projector which can overcome the above described shortcomings.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of one embodiment of a projector.

FIG. 2 is a schematic view of one embodiment of a color wheel of the projector shown in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

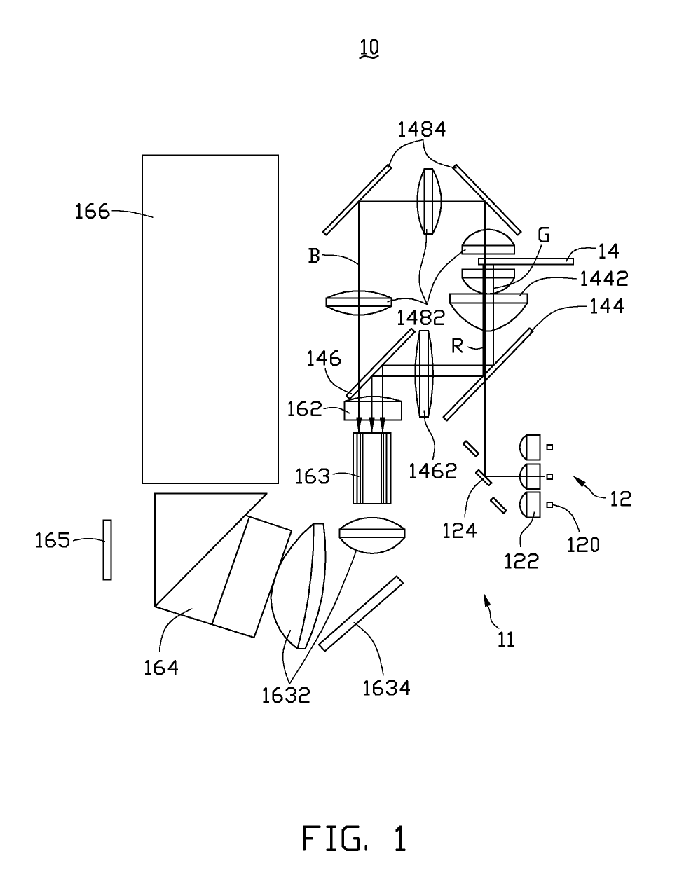

According to one embodiment, a projector 10 as illustrated in FIG. 1 includes a light source device 11, a light merging unit 162, a light guide unit 163, a prism unit 164, a digital micro-mirror device (DMD) 165, and a projection lens set 166. The projector 10 also comprises a number of mirrors 1634, 124, and 1484 and a number of lenses, 1632, 1442, 1462, and 1482. The light source device 11 and the projection lens set 166 are positioned at two sides of the projector 10. In one embodiment, the light guide unit 163 is a light tunnel. The prism unit 164 is a reverse total internal reflection (TIR) prism including two prisms combined together.

The light source device 11 includes a laser light source 12, a color wheel 14, a first dichroic mirror 144, and a second dichroic mirror 146. The laser light source 12, the lenses 1482, the mirrors 124, the first dichroic mirror 144, the second dichroic mirror 146, and the color wheel 14 are positioned in the light source device 11 along an optical path. The lens 1462 is positioned between the first dichroic mirror 144 and the second dichroic mirror 146.

When the projector 10 operates, the laser light source 12 generates a first light along the optical path. In one embodiment, the laser light source 12 includes a number of laser generators 120 for generating a blue light B. In one embodiment, the laser light source 12 includes three laser generators 120. The lens 122 focus the blue light B generated by the laser light source 12. The mirror 124 reflects the focused blue light B through the first dichroic mirror 144 to a surface of the color wheel 14.

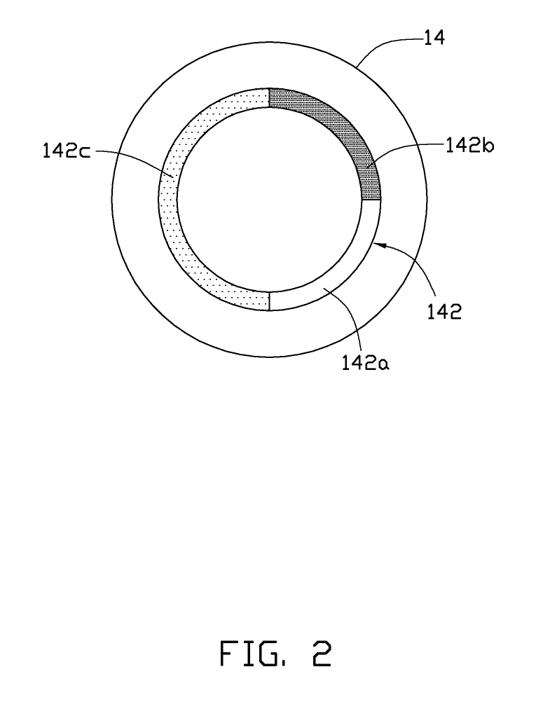

Referring to FIG. 2, the surface of the color wheel 14 includes an annular irradiative area 142. The annular irradiative area 142 has a first irradiative area 142a, a second irradiative area 142b, and a third irradiative area 142c. The first irradiative area 142a is a transparent area without phosphor layer. A first phosphor layer is applied on the second irradiative area 142b. A second phosphor layer is applied on the third irradiative area 142c When the blue light B irradiates the second irradiative area 142b of the color wheel 14, the first phosphor layer of the second irradiative area 142b generates a second light due to the irradiation of the blue light B. In one embodiment, the second light is a red light R. When the blue light B irradiates the third irradiative area 142c of the color wheel 14, the second phosphor layer of the third irradiative area 142c generates a third light due to the irradiation of the blue light B. In one embodiment, the third light is a green light G.

The red light R irradiates the first dichroic mirror 144 through the lens 1442. Similarly, the green light G irradiates the first dichroic mirror 144 through the lens 1442. The first dichroic mirror 144 reflects the red light R and the green light G to the second dichroic mirror 146 through the lens 1462. In other words, the red light R and the green light G irradiate the second dichroic mirror 146 via the lenses 1442, 1462 and the first dichroic mirror 144. The second dichroic mirror 146 reflects the red light R and the green light G to the light merging unit 162. The lens 1442 focuses the red light R generated by the first phosphor layer of the second irradiative area 142b and the green light G generated by the second phosphor layer of the third irradiative area 142c.

When the blue light B irradiates the first irradiative area 142a of the color wheel 14, the blue light B passes through the first irradiative area 142a of the color wheel 14 and irradiates the second dichroic mirror 146 via two mirrors 1484 and three lenses 1482 due to the transparency of the first irradiative area 142a. Afterward, the blue light B passes through the second dichroic mirror 146 to the light merging unit 162.

The light merging unit 162 merges the blue light B generated by the laser light source 12, the red light R generated by the first phosphor layer of the second irradiative area 142b, and the green light G generated by the second phosphor layer of the third irradiative area 142c to generate a mixed light. The light guide unit 163 guides the mixed light to the prism unit 164 by the reflection of the mirror 1634 and the focusing of the lens 1632. The mixed light is refracted to the DMD 165 via the prism unit 164. The refracted mixed light is reflected to the projection lens set 166 via the DMD 165. In this way, the projector 10 can project an image on a screen.

It is to be understood that the above-described embodiments are intended to illustrate rather than limit the disclosure. Any element described in accordance with any embodiments is understood to be usable additionally or in substitution for elements in other embodiments. Embodiments can also be used together. Variations may be made to the embodiments without departing from the spirit of the disclosure. The above-described embodiments illustrate the scope of the disclosure but do not restrict the scope of the disclosure.

What is claimed is:

1. A light source device for a projector, comprising:
a laser light source, positioned in an optical path, the laser light source being configured for generating a first light along the optical path; and
a color wheel positioned in the optical path;
wherein the first light irradiates the color wheel, and the color wheel generates a second light and a third light due to the irradiation of the first light.

2. The light source device as claimed in claim 1, further comprising a first dichroic mirror and a second dichroic mirror positioned in the optical path, wherein the first light transmits through the first dichroic mirror and the color wheel and then irradiates the second dichroic mirror, and the second and third lights are reflected by the first dichroic mirror and then irradiate the second dichroic mirror.

3. The light source device as claimed in claim 2, further comprising a lens positioned between the first and second dichroic mirrors, wherein the reflected second light and the reflected third light irradiate the second dichroic mirror through the lens.

4. The light source device as claimed in claim 2, further comprising a mirror being configured for reflecting the first light from the laser light source to the first dichroic mirror.

5. The light source device as claimed in claim 1, wherein the color wheel comprises a plurality of irradiative areas, each irradiative area has a phosphor layer, the first light irradiates the plurality of irradiative areas to generate the second light and the third light.

6. The light source device as claimed in claim 1, wherein the color wheel has a surface comprising an annular irradiative area, the annular irradiative area comprises a first irradiative area, a second irradiative area with a first phosphor layer, and a third irradiative area with a second phosphor layer, the first irradiative area is a transparent area without phosphor layer, the first light irradiates the first phosphor layer of the second irradiative area to generate the second light, irradiates the second phosphor layer of the third irradiative area to generate the third light, and transmits through the first irradiative area.

7. The light source device as claimed in claim 1, wherein the first light is a blue light, the second light is a red light, and the third light is a green light.

8. A projector, comprising:
a light source device comprising:
a laser light source, positioned in an optical path, the laser light source being configured for generating a first light along the optical path; and
a color wheel positioned in the optical path, wherein the first light irradiates the color wheel, and the color wheel generates a second and a third light due to the irradiation of the first light;
a light merging unit configured for merging the first, second, and third lights to generate a mixed light;
a projection lens set;
a digital micro-mirror device (DMD);
a prism unit; and
a light guide unit configured for guiding the mixed light to the prism unit;
wherein the mixed light is refracted to the DMD via the prism unit, and then the refracted mixed light is reflected to the projection lens set via the DMD.

9. The projector as claimed in claim 8, wherein the light source device further comprises a first dichroic mirror and a second dichroic mirror positioned in the optical path, the first light transmits through the first dichroic mirror and the color wheel and then irradiates the second dichroic mirror, and the second and third lights are reflected by the first dichroic mirror and then irradiate the second dichroic mirror.

10. The projector as claimed in claim 9, wherein the light source device further comprises a lens positioned between the first and second dichroic mirrors, and the reflected second light and the reflected third light irradiates the second dichroic mirror through the lens.

11. The projector as claimed in claim 9, wherein the light source device further comprises a mirror configured for reflecting the first light from the laser light source to the first dichroic mirror.

12. The projector as claimed in claim 8, wherein the color wheel of the light source device comprises a plurality of irradiative areas, each irradiative area has a phosphor layer, the first light irradiates the plurality of irradiative areas to generate the second light and the third light.

13. The projector as claimed in claim 8, wherein the color wheel has a surface comprising an annular irradiative area, the annular irradiative area comprises a first irradiative area, a second irradiative area with a first phosphor layer, and a third irradiative area with a second phosphor layer, the first irradiative area is a transparent area without phosphor layer; the first light irradiates the first phosphor layer of the second irradiative area to generate the second light, irradiates the second phosphor layer of the third irradiative area to generate the third light, and transmits through the first irradiative area to the light merging unit.

14. The projector as claimed in claim 8, wherein the prism unit is a reverse total internal reflection (TIR) prism.

15. The projector as claimed in claim 14, wherein the reverse TIR prism comprises two prisms combined together.

16. The projector as claimed in claim 8, wherein the first light is a blue light, the second light is a red light, and the third light is a green light.
